(19) United States
(12) Patent Application Publication
(10) Pub. No.: US 2023/0290235 A1
(43) Pub. Date: Sep. 14, 2023

(54) SYSTEM AND METHOD FOR PROVIDING EVACUATION GUIDANCE

(71) Applicant: Johnson Controls Tyco IP Holdings LLP, Milwaukee, WI (US)

(72) Inventors: Siddhesh K NAGALE, Pune (IN); Ganesh B. KAKADE, Pune (IN); Chetan M. HATKAR, Kolhapur (IN); Rohan S. DEVARDEKAR, Pune (IN); Mahesh J. PHARANDE, Pune (IN); Megha S. BHILARE, Pune (IN); Aswin VIJAYAN, Pune (IN)

(21) Appl. No.: 18/181,404

(22) Filed: Mar. 9, 2023

(30) Foreign Application Priority Data
Mar. 9, 2022 (IN) 202221012712

(51) Int. Cl. G08B 7/06; G08B 5/38

(52) U.S. Cl. CPC G08B 7/066; G08B 5/38

(57) ABSTRACT

The present disclosure relates to a system for providing evacuation guidance. The system comprises a plurality of sensors. Each sensor is configured to monitor at least one parameter of an indoor space and generate sensed data. The system further comprises one or more visual indicators associated with each sensor and a processing circuit configured to analyze the sensed data to detect occurrence of an event. The processing circuit generates one or more evacuation paths subsequent to detection of the event and operates the one or more visual indicators associated with each sensor to provide directional information to occupants based on the one or more evacuation paths.

### BACKGROUND

The present disclosure relates generally to a system and method for providing evacuation guidance in case of emergency situations.

Generally, public areas such as shopping malls, airports, university campuses, amusement parks, corporate buildings, technology parks etc., are prone to hazardous events such as fire, gas leakage, earthquakes, terrorist attack, gunshot etc. Typically, conventional systems utilize pre-set evacuation plans for guiding building occupants towards safe exit in case of occurrence of such hazardous events in buildings. The pre-set evacuation plans generally include static drawings or other instructions such as exit signs posted in common areas to inform building occupants of primary and alternate emergency exit routes. It is commonly expected that building occupants will take notice and review information provided on the pre-set evacuation plans in case of occurrence of hazardous events.

However, conventional systems fail to adapt according to different emergency situations. For example, during a fire event, the pre-set evacuation plans posted in common areas may not be visible in case of dense smoke. Also, during such emergency situations, building occupants are not always able to check the posted evacuation plans properly, thereby leading to confusion and panic. In addition, legacy evacuation plans, like floor plans are often difficult to understand. One or more notification appliances are also used by the conventional systems such as speakers to notify about occurrence of hazardous events and assist building occupants in evacuating the building. However, notification appliances such as speakers providing audio warnings are not a preferable way to notify hearing-impaired occupants.

Furthermore, in some situations one or more emergency exits are blocked. For example, a fire event may cause certain emergency exit paths to become dangerous and unusable. In such situations, alternate evacuation paths are required for assisting building occupants. However, the pre-set evacuation plans fail to assist building occupants in providing alternate evacuation paths due to non-dynamic nature.

There is therefore felt a need for systems and methods that provide dynamic evacuation plans to guide building occupants during occurrence of hazardous events.

### SUMMARY

One implementation of the present disclosure relates to a system comprising a plurality of sensors. Each sensor is configured to monitor at least one parameter of an indoor space and generate sensed data. Further, the system comprises one or more visual indicators associated with each sensor and a processing circuit configured to analyze the sensed data to detect occurrence of an event. The processing circuit generates one or more evacuation paths subsequent to detection of the event and operates the one or more visual indicators associated with each sensor to provide directional information to occupants based on the one or more evacuation paths.

Another implementation of the present disclosure relates to a method comprising steps performed by a processing circuit that include analyzing sensed data to detect occurrence of an event. The sensed data is generated by a plurality of sensors monitoring at least one parameter of an indoor space. Further, the steps performed by the processing circuit include generating one or more evacuation paths subsequent to detection of the event and operating one or more visual indicators associated with each sensor to provide directional information to occupants based on the one or more evacuation paths.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS) and a fire system, according to some embodiments.

FIG. 2 is a perspective view of the building of FIG. 1, including rooms, occupants, fire notification devices, fire suppression devices, and fire detection devices of the fire system, according to some embodiments.

FIG. 3 is a perspective view of various rooms of the building of FIG. 1, including occupants, notification devices, and fire detection devices of the fire system, according to some embodiments.

FIG. 4 is a block diagram of the fire system of FIG. 1, according to some embodiments.

FIG. 5 is block diagram of a system for providing evacuation guidance, according to some embodiments.

FIG. 6 is a schematic diagram showing an example of a floorplan displaying evacuation paths in case of a fire event detected in a room, according to some embodiments.

FIG. 7 is a schematic diagram showing an example of a floorplan displaying evacuation paths in case of a fire event detected near an emergency exit, according to some embodiments.

FIG. 8 is a schematic diagram showing an example of a floorplan displaying evacuation paths in case of a fire event detected in a corridor, according to some embodiments.

FIG. 9 shows an example of security devices of FIG. 5, according to some embodiments.

FIG. 10 is a schematic diagram showing an example of an evacuation path displayed by the system of FIG. 5 for color blind occupants, according to some embodiments.

FIG. 11 is a flow chart of a method for providing evacuation guidance through LED rings, according to some embodiments.

FIG. 12 is a schematic diagram showing an assembly having a smoke detector and oxygen sensor, according to some embodiments.

FIG. 13 is a schematic diagram showing a visual indicator associated with the smoke detector of FIG. 12, according to some embodiments.

FIG. 14 is a schematic diagram showing wiring details of the assembly of FIG. 12, according to some embodiments.

FIG. 15 is a schematic diagram showing another view of the assembly of FIG. 12, according to some embodiments.

FIG. 16 is a schematic diagram showing an example of a floor plan displaying evacuation paths in case of oxygen deficiency in a closed room, according to some embodiments.

FIG. 17 is a schematic diagram showing an example of a floor plan displaying evacuation paths in case of oxygen deficiency in corridors, according to some embodiments.

FIG. 18 is a flow chart of a method for providing evacuation guidance through LED strips, according to some embodiments.

FIG. 19 shows an example of a building space with smoke detectors triggering an alarm, according to some embodiments.

FIG. 20 is a schematic diagram showing an example of an evacuation path displayed by illuminating direction signages, according to some embodiments.

FIG. 21 is an example of direction signages for providing evacuation guidance, according to some embodiments.

FIG. 22 is a flow chart of a method for providing evacuation guidance through illuminating direction signages, according to some embodiments.

### DETAILED DESCRIPTION

Before turning to the Figures, it should be understood that the disclosure is not limited to the details or methodology set forth in the description or illustrated in the figures. It should also be understood that the terminology is for the purpose of description only and should not be regarded as limiting.

Referring generally to the Figures, a system for providing evacuation guidance is shown and described. The system may be utilized in conjunction with a plurality of building automation or management systems, subsystems, or as a part high level building automation system. For example, the system may be a part of a Johnson Controls Facility Explorer system.

The present disclosure describes systems and methods that address the shortcomings of conventional systems. As referred in the background, conventional systems fail to provide dynamic evacuation paths to occupants according to different emergency situations.

The present disclosure overcomes the shortcomings of the conventional systems by providing dynamic evacuation paths to occupants according to different emergency situations. For example, embodiments of the system disclosed herein incorporate visual indicators associated with sensors. The visual indicators are operated to emit one or more colors to provide directional information to occupants for navigating along a safest and shortest evacuation path. Further, the evacuation path may be updated by operating the visual indicators to update the one or more colors, thereby displaying an updated evacuation path. The present system provides dynamic evacuation paths in real-time to allow occupants to reach safest emergency exits in minimal time. Additionally, if one or more emergency exits are compromised by an emergency situation, the evacuation path is updated in real-time to alert occupants to avoid the compromised emergency exit and safely evacuate the building using the updated evacuation path.

### Building Management System and Fire System

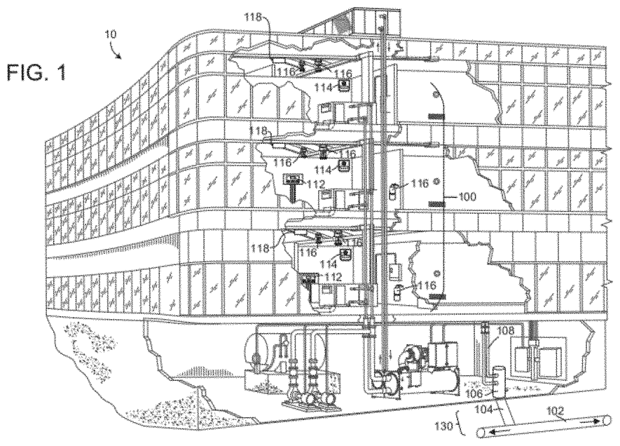

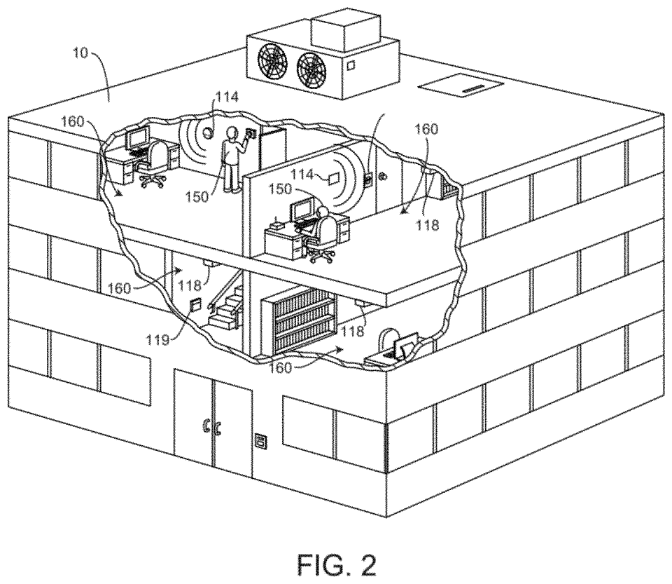

Referring now to FIGS. 1-4, a building management system (BMS) and fire suppression system are shown, according to some embodiments. Referring particularly to FIG. 1, a perspective view of a building 10 is shown. Building 10 is served by a building management system (BMS), according to some embodiments. A BMS is, in general, a system of devices configured to control, monitor, and manage equipment in or around a building or building area, according to some embodiments. A BMS can include, for example, a fire suppression system, a security system, a lighting system, a fire detection system, any other system that is capable of managing building functions or devices, or any combination thereof.

The BMS that serves building 10 includes a fire system 100 (e.g., a fire detection and/or fire suppression system), according to some embodiments. Fire system 100 can include fire safety devices (e.g., notification devices such as fire detectors and pull stations, sprinklers, fire alarm control panels, fire extinguishers, water systems etc.) configured to provide fire detection, fire suppression, fire notification to building occupants 150, or other fire suppression-related services for building 10. Fire system 100 includes water system 130, according to some embodiments. Water system 130 provides water from a city line 102 through a building line 104 to building 10 to suppress fires within one or more rooms/spaces of building 10, according to some embodiments. In some embodiments, a main water line 106 is the dominant piping system that distributes water throughout one or more of the building floors in building 10. The water is distributed to the one or more building floors of building 10 via a piping system 108, according to some embodiments.

Referring still to FIGS. 1-4, fire system 100 can also include fire detection devices 118, fire notification devices 114, and fire suppression devices 116 positioned in various rooms/spaces 160 of building 10. Fire suppression devices 116 may include sprinklers, fire extinguishers, etc., or any other device configured to suppress a fire. Fire suppression devices 116 may be positioned in various rooms 160 of building 10. Fire suppression devices 116 may be connected to piping system 108 and serve as one of the corrective actions taken by fire system 100 to suppress fires. In some embodiments, fire suppression devices 116 can engage in suppressive action using dry agents (nitrogen, foam, non-fluorinated foam, air, etc.) instead of water. One or more of the fire suppression devices may be a portable device capable of discharging a fire suppressing agent (e.g., water, foam, gas, etc.) onto a fire. Building 10 may include fire extinguishers (e.g., portable fire suppression devices) on several floors in multiple rooms 160. Fire system 100 can also include one or more pull stations 119 configured to receive a manual input from an occupant 150 of building 10 to indicate the presence of a fire. Pull stations 119 may include a lever, a button, etc., configured to receive a user input indicating that a fire has occurred in building 10. In some embodiments, pull stations 119 are configured to provide a signal to fire alarm control panel 112 regarding a status of the lever, button, etc. When an occupant 150 pulls the lever or pushes the button (or more generally inputs to any of pull stations 119 that there is an emergency situation in building 10), pull stations 119 provide fire alarm control panel 112 with an indication that an occupant 150 of building 10 has actuated one of the pull stations 119. In some embodiments, the indication includes an identification of the particular pull station 119 that has been actuated and a location of the particular pull station 119 (e.g., what floor the fire is at, what room the fire is in, etc.).

Fire notification devices 114 can be any devices capable of relaying audible, visible, or other stimuli to alert building occupants of a fire or other emergency condition. In some embodiments, fire notification devices 114 are powered by Initiating Device Notification Alarm Circuit (IDNAC) power from fire alarm control panel 112. In some embodiments, fire notification devices 114 may be powered by a DC power source (e.g. a battery). In some embodiments, fire notification devices 114 are powered by an external AC power source. Fire notification devices 114 can include a light notification device (e.g., a visual alert device) and a sound notification device (e.g., an aural alert device). The light notification device can be implemented as any component in fire notification devices 114 that alerts occupants 150 of an emergency by emitting visible signals. In some embodiments, fire notification devices 114 include a strobe light configured to emit strobe flashes (e.g., at least 60 flashes per minute) to alert occupants 150 of building 10 of an emergency situation or regarding the presence of a fire 180. A sound notification device can be any component in fire notification devices 114 that alerts occupants of an emergency by providing an aural alert/alarm. In some embodiments, fire notification devices 114 emit signals ranging from approximately 500 Hz (low frequency) to approximately 3 kHz (high frequency).

Fire alarm control panel 112 can be any computer capable of collecting and analyzing data from the fire notification system (e.g., building controllers, conventional panels, addressable panels, etc.). In some embodiments, fire alarm control panel 112 is directly connected to fire notification device 114 through IDNAC power. In some embodiments, fire alarm control panel 112 can be communicably connected to a network for furthering the fire suppression process, including initiating corrective action in response to detection of a fire.

In some embodiments, fire detection devices 118 are configured to detect a presence of fire in an associated room 160. Fire detection devices 118 may include any temperature sensors, light sensors, smoke detectors, etc., or any other sensors/detectors that detect fire. In some embodiments, fire detection devices 118 provide any of the sensed information to fire alarm control panel 112.

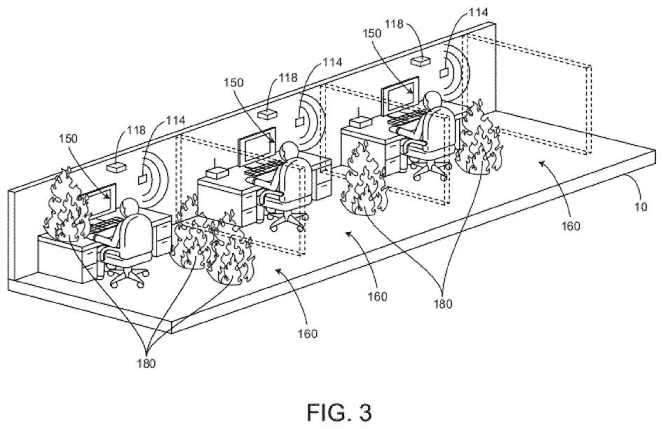

Referring particularly to FIG. 3, a perspective view of various rooms of building 10 is shown, according to some embodiments. In some embodiments, fire detection devices 118 are configured to monitor any of a temperature, a light intensity, a presence of smoke, etc., of a corresponding room/space 160 of building 10. Fire detection devices 118 can be configured to locally perform a fire detection process to determine if a fire 180 is present in room/space 160 based on the sensed data (e.g., the sensed room temperature, the sensed light intensity in room 160, the sensed smoke in room 160, etc.), according to some embodiments. In some embodiments, fire detection devices 118 provide any of the sensed information (e.g., the room temperature of room 160, the light intensity within room 160, the presence of smoke within room 160, etc.) to fire alarm control panel 112. Fire alarm control panel 112 is configured to receive any of the sensor information from any of fire detection devices 118 throughout building 10 and perform a fire detection process to determine if a fire 180 is present in any rooms/spaces 160 of building 10, according to some embodiments. In some embodiments, fire alarm control panel 112 is configured to cause fire notification devices 114 to provide any of a visual and/or an aural alert to occupants 150 in response to determining that a fire 180 is present in one of rooms 160 of building 10. In some embodiments, fire alarm control panel 112 is configured to cause a specific fire notification device 114 to provide an alarm/alert to an occupant 150 of a particular room/space 160 in response to determining that a fire 180 is present in the particular room/space 160 of building 10.

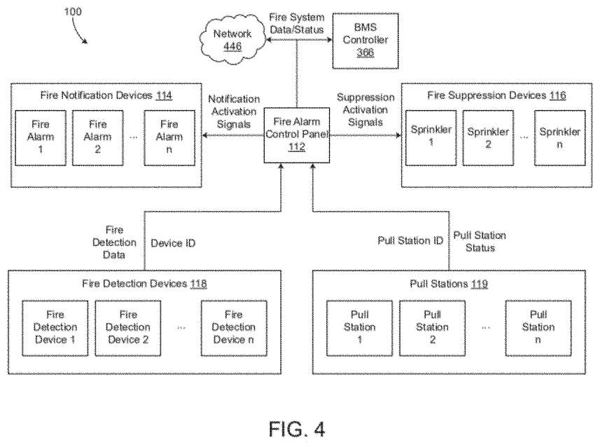

In some embodiments, fire alarm control panel 112 is configured to provide a BMS controller 366 (see FIG. 4) with a status of any of fire notification devices 114 and/or any of the collected information/data from fire detection devices 118. For example, fire alarm control panel 112 may provide BMS controller 366 with an indication of a current status (e.g., normal mode, alarm mode, etc.) of any of fire notification devices 114. In some embodiments, fire alarm control panel 112 is configured to cause one or more of fire suppression device 116 to suppress the fire in response to determining that a fire is present in building 10. In some embodiments, fire alarm control panel 112 is configured to cause a particular fire suppression device 116 to suppress a fire in a particular room/space 160 in response to determining that a fire 180 is present in the particular room/space 160. In some embodiments, fire alarm control panel 112 is configured to provide BMS controller 366 with a status (e.g., activated, dormant, etc.) of any or all of fire suppression devices 116.

### Fire Detection System

Referring particularly to FIG. 4, fire system 100 is shown in greater detail, according to some embodiments. As shown, fire alarm control panel 112 can be configured to receive any fire detection data (e.g., smoke detection, heat/temperature detection, light intensity detection, etc.) from any of fire detection devices 118. In some embodiments, fire alarm control panel 112 also receives a unique device ID (e.g., an identification number, an identification code, etc.) from each of fire detection devices 118. In some embodiments, fire alarm control panel 112 is configured to determine a location in building 10 of each of fire detection device 118 based on the unique device ID received from each of fire detection devices 118. For example, fire alarm control panel 112 can determine that a particular fire detection device 118 is located in a certain room, on a certain floor of building 10.

In some embodiments, fire alarm control panel 112 also receives pull station status information from any of pull stations 119 throughout building 10. In some embodiments, fire alarm control panel 112 is configured to receive a unique pull station ID (e.g., an identification number, an identification name, a unique ID code, etc.) from each of pull stations 119. In some embodiments, fire alarm control panel 112 is configured to perform a fire detection process based on any of the pull station status information received from pull stations 119 and the fire detection data received from fire detection devices 118. Fire alarm control panel 112 can also determine an approximate location of a fire based on the received device IDs of fire detection devices 118 and the received pull station IDs from pull stations 119.

In some embodiments, fire alarm control panel 112 is configured to cause fire notification devices 114 and/or fire suppression devices 116 to activate in response to determining that a fire is present in building 10. In some embodiments, fire alarm control panel 112 uses a database of locations corresponding to each of the unique device IDs of fire detection devices 118 and pull stations 119. In some embodiments, fire alarm control panel 112 is configured to determine an approximate location in building 10 of the fire. In some embodiments, fire alarm control panel 112 is configured to cause particular fire notification devices 114 and particular fire suppression devices 116 to activate in response to determining that a fire is present in a particular room 160 of building 10.

For example, fire alarm control panel 112 may cause all of fire notification devices 114 to activate in response to determining that a fire is present in any room 160 of building 10. In some embodiments, fire alarm control panel 112 is configured to cause only fire suppression devices 116 that are proximate the location of the detected fire to activate. For example, fire alarm control panel 112 may cause all fire notification devices 114 to activate in response to determining a fire is present in one room 160 of building 10 (to cause occupants 150 to evacuate building 10) but may only activate fire suppression devices 116 that are in the particular room where the fire is present.

In some embodiments, fire detection devices 118 are configured to perform a fire detection process locally and are communicably connected with fire notification devices 114. In some embodiments, fire detection devices 118 are configured to provide fire alarm control panel 112 with an indication of whether a fire is present nearby fire detection devices 118. In some embodiments, fire detection devices 118 are configured to cause fire notification devices 114 to activate in response to determining that a fire is present nearby. In some embodiments, fire detection devices 118 are configured to control an operation of fire suppression devices 116. In some embodiments, fire detection devices 118 are configured to cause one or more (e.g., the nearest) of fire suppression devices 116 to activate in response to detecting a fire.

In some embodiments, fire alarm control panel 112 is configured to provide a status of fire system 100 to network 446 and/or BMS controller 366. For example, fire alarm control panel 112 may provide a status of each of fire suppression devices 116 (e.g., activated or dormant), a status of each of fire notification devices 114 (e.g., activated or dormant), a status of each of fire detection devices 118 (e.g., fire detected, no fire detected), and a status of each of pull stations 119 (e.g., activated). In some embodiments, fire alarm control panel 112 also provides network 446 and/or BMS controller 366 with a location of each of fire notification devices 114, fire suppression devices 116, fire detection devices 118, and pull stations 119. In some embodiments, the location includes a floor, room, and relative location within the room of each of fire notification devices 114, each of fire suppression devices 116, each of fire detection devices 118, and each of pull stations 119. For example, fire alarm control panel 112 may provide BMS controller 366 with a status of a particular fire detection device 118, as well as what floor the particular fire detection device 118 is on, as well as a room 160 that the particular fire detection device 118 is in and what wall of the room (e.g., north wall, west wall, etc.) 160 the particular fire detection device 118 is located on. In some embodiments, fire alarm control panel 112 is configured to provide BMS controller 366 with any of the received information from any or all of fire detection devices 118, any or all of pull stations 119, etc. For example, fire alarm control panel 112 may provide BMS controller 366 with any of the smoke detection data, the temperature sensed data, the light intensity data, etc., of each of fire detection devices 118 as well as the corresponding room 160 within which each of fire detection devices 118 are located.

### Evacuation Guidance

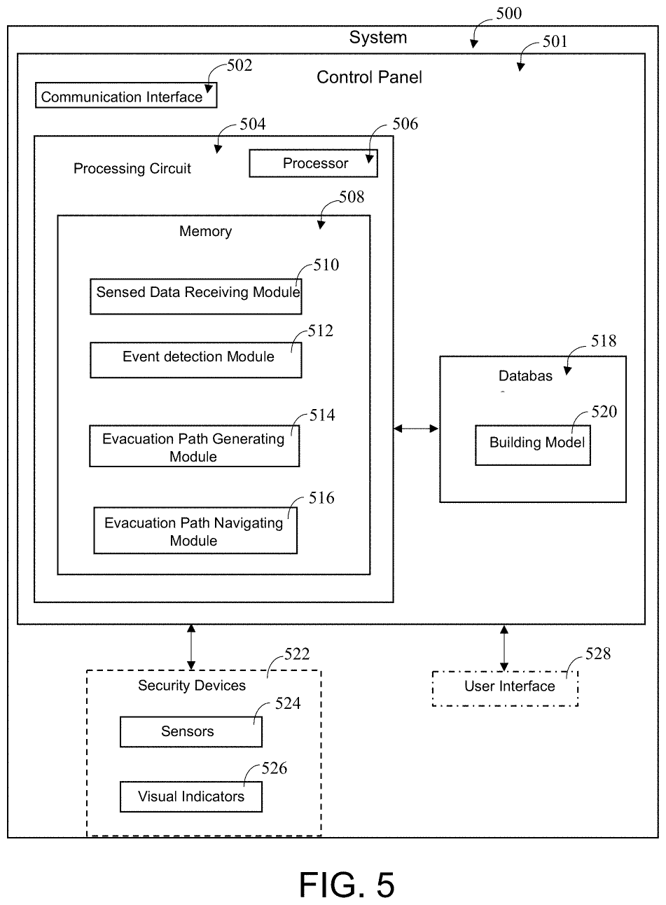

Referring now to FIG. 5, a block diagram illustrating a system 500 for providing evacuation guidance is shown, according to some embodiments. System 500 is shown to include a control panel 501, security devices 522, a user interface 528. In some embodiments, the control panel 501 may be the fire alarm control panel 112 referred above in FIGS. 1-4. The control panel 501 is shown to include a communication interface 502, a processing circuit 504 and a database 518.

Communication interface 502 may include wired or wireless interfaces (e.g., jacks, antennas, transmitters, receivers, transceivers, wire terminals, etc.) for conducting data communications with various systems, devices, or networks. For example, communication interface 502 may include an Ethernet card and port for sending and receiving data via an Ethernet-based communications network and/or a Wi-Fi transceiver for communicating via a wireless communications network. Communication interface 502 may be configured to communicate via local area networks or wide area networks (e.g., the Internet, a building WAN, etc.) and may use a variety of communication protocols (e.g., BACnet, IP, LON, etc.). Communication interface 502 may be a network interface configured to facilitate electronic data communications between the control panel 501 and various external systems or devices (e.g., user interfaces 528, security devices 522 etc.)

The processing circuit 504 is shown to include a processor 506 and a memory 508. In some embodiments, the processing circuit 504 can be a processing circuit of the building management systems (BMS) described above. The processor 506 may be a general purpose or specific purpose processor, an application specific integrated circuit (ASIC), one or more field programmable gate arrays (FPGAs), a group of processing components, or other suitable processing components. The processor 506 may be configured to execute computer code or instructions stored in memory 508 or received from other computer readable media (e.g., CDROM, network storage, a remote server, etc.).

The memory 508 may include one or more devices (e.g., memory units, memory devices, storage devices, etc.) for storing data and/or computer code for completing and/or facilitating the various processes described in the present disclosure. The memory 508 may include random access memory (RAM), read-only memory (ROM), hard drive storage, temporary storage, non-volatile memory, flash memory, optical memory, or any other suitable memory for storing software objects and/or computer instructions. The memory 508 may include database components, object code components, script components, or any other type of information structure for supporting various activities and information structures described in the present disclosure. The memory 508 may be communicably connected to the processor 506 via the processing circuit 504 and may include computer code for executing (e.g., by processor 506) one or more processes described herein.

Still referring to FIG. 5, the control panel 501 is shown to include the database 518. The database 518 is configured to store various types of information such as a building model 520. In some embodiments, the building model 520 may be obtained based on Building Information Modeling (BIM). The building model 520 may include digital representations of physical and functional characteristics of a building. The building model 520 may represent a building and its equipment via electronic maps such as 2D maps, 3D maps etc. Building model 520 may provide information on various aspects of the building such as floorplan, locations of objects (like building points, building equipment, lights, furniture, doors, windows, stairs, elevators, emergency exits etc.), depth information for objects, building layouts, devices information etc.

In some embodiments, the database 518 may further comprise a knowledge base that may include historical data such as previous commands generated by the control panel 501, device information, etc. In some embodiments, the database 518 may store data pertaining to security devices 522 such as unique identifiers, location of installation within the building, predetermined threshold values etc.

Still referring to FIG. 5, the control panel 501 is shown to be in communication with the security devices 522. In some embodiments, the control panel 501 may communicate with the security devices 522 via the communication interface 502. In some embodiments, the security devices 522 may include a plurality of sensors 524 that are configured to monitor at least one parameter of an indoor space. In some embodiments, the sensors 524 may include at least one of, but not limited to, smoke detector, oxygen sensor, heat sensor, flame detector, gas sensor, toxic fumes detector, water detector, CO detector, shot detection sensor, temperature sensor, security cameras, motion sensors, occupancy sensor, proximity sensor, chemical sensors, sound detector, light sensor, access devices (e.g., RFID locks, biometric locks, door locks, etc.), and the like.

In some embodiments, the sensors 524 may be configured to monitor the at least one parameter of the indoor space, generate sensed data pertaining to the at least one parameter and further provide the sensed data to the control panel 501 via the communication interface 502. For example, the sensed data may include information pertaining to the at least one parameter such as smoke, oxygen, occupancy, pressure, temperature, humidity, sound, motion etc. In some embodiments, the sensed data may include video and/or digital images provided by the sensors 524 such as security cameras. Additionally, unique identifiers of the one or more sensors 524 may be transmitted along with the sensed data to the sensed data receiving module 510.

In some embodiments, the security devices 522 may include one or more visual indicators 526. In some embodiments, one or more visual indicators 526 may be associated with each of the sensors 524. In some embodiments, the visual indicators 526 may be integrated into the sensors 524. In other embodiments, the visual indicators 526 may be mounted on the sensors 524. In some embodiments, the visual indicator 526 is one of an light emitting diode (LED) ring, an LED strip, an illuminating direction signage, or any combination thereof. In one embodiment, the visual indicators 526 may be single colored. For example, each sensor 524 may be provided with one or more single-colored visual indicators 526 that may emit a single color to provide directional information. In an alternate embodiment, the visual indicators 526 may be multi-colored to emit two or more colors to provide directional information in one of several ways. For example, each sensor 524 may be provided with one or more visual indicators 526 that may be operated to emit two or more colors. The visual indicators 526 may be used to provide directional information through visual indication of evacuation paths in response to one or more commands received from the control panel 501.

Still referring to FIG. 5, the control panel 501 is shown to be in communication with the user interface 528, typically, via the communication interface 502. In some embodiments, the user interface 528 may be associated with an electronic device of a user. In an embodiment, the electronic device can be selected from, but not limited to, smart phones and/or mobile devices, desktop, computer, laptop and netbook computing devices, tablet computing devices, digital media devices, personal digital assistant (PDA), wearable devices (e.g., optical head mounted display, smartwatch, etc.), and any other device having communication capabilities and/or processing capabilities. In some embodiments, the user interface 528 may be associated with a user such as a security admin of a building.

Still referring to FIG. 5, the control panel 501 is shown to include a sensed data receiving module 510. The sensed data receiving module 510 may be configured to receive sensed data from one or more sensors 524. As referred above, the sensed data may include values of the at least one parameter monitored by the sensors 524 such as smoke, oxygen, occupancy, pressure, temperature, humidity, sound, motion etc.

Still referring to FIG. 5, the control panel 501 is shown to include an event detection module 512. The event detection module 512 may be configured to communicate with the sensed data receiving module 510 to obtain the sensed data. Further, the event detection module 512 may be configured to analyze the sensed data to detect occurrence of one or more events within the building. For example, the one or more events may include at least one of, but not limited to, fire, flood, earthquake, oxygen deficiency, terrorist attack, gunshot, gas leakage, damaging of one or more building equipment and the like. The event detection module 512 may compare the sensed data with one or more predetermined threshold values stored in the database 518. For example, the event detection module 512 may be configured to detect occurrence of one or more events such as fire, when sensed data provided by one or more smoke detectors exceeds the predetermined threshold value. In another example, the event detection module 512 may be configured to detect oxygen deficiency within the building, when sensed data such as measured oxygen level provided by the oxygen detector falls below the predetermined threshold value.

In some embodiments, the event detection module 512 may analyze the sensed data received from multiple sensors 524. For example, the event detection module 512 may evaluate sensed data from fire sensors, smoke detectors, heat sensors, thermal imagers, and other fire system sensors to determine that it is likely that a fire event has occurred in the building. Thus, by analyzing sensed data from multiple sensors 524, a probability of detecting a false event may be reduced significantly. In some embodiments, the event detection module 512 may utilize one or more machine learning models stored in the database 518 to analyze the sensed data for detection of one or more events. In some embodiments, the event detection module 512 may generate one or more notifications to the user interface 528 in response to detection of one or more events.

Still referring to FIG. 5, the control panel 501 is shown to include an evacuation path generating module 514. The evacuation path generating module 514 may be configured to communicate with the sensed data receiving module 510 and the event detection module 512 to obtain the sensed data and information on the detected event. The evacuation path generating module 514 may determine and generate one or more safest and shortest evacuation paths for occupants subsequent to detection of the event. As referred above, the unique identifiers of the one or more sensors 524 may be transmitted along with the sensed data to the sensed data receiving module 510. Thus, the unique identifiers of the one or more sensors 524 generating the sensed data may be determined. Further, the evacuation path generating module 514 may determine a location of installation of the one or more sensors 524 based on the unique identifier of the one or more sensors 524 by using the pre-stored building model 520 in the database 518. Further, the evacuation path generating module 514 may determine a location of occurrence of the event within the building based on the location of installation of the one or more sensors 524.

The evacuation path generating module 514 may further determine one or more emergency exits and one or more paths to the one or more emergency exits using the pre-stored building model 520. The location of event may be analyzed with respect to the location of the one or more emergency exits to check if the occurrence of event is detected nearby any of the emergency exits. Further, the evacuation path generating module 514 may determine and generate one or more evacuation paths to the one or more emergency exits based on the analysis of the location of the event and the location of the one or more emergency exits. The one or more evacuation paths may be generated by avoiding the paths nearby the location of the detected event. In some embodiments, evacuation path generating module 514 may utilize one or more artificial intelligence and/or machine learning based models stored in the database 518 to determine the one or more evacuation paths for occupants.

Still referring to FIG. 5, the control panel 501 is shown to include an evacuation path navigating module 516. The evacuation path navigating module 516 may be configured to communicate with the sensed data receiving module 510, the event detection module 512, and the evacuation path generating module 514. The evacuation path navigating module 516 may display the one or more evacuation paths generated by the evacuation path generating module 514 to allow occupants to navigate along the one or more evacuation paths. The evacuation path navigating module 516 may be configured to operate the visual indicators 526 associated with the sensors 524 to emit one or more colors. In some embodiments, the one or more colors may provide one or more types of directional information for occupants to safely evacuate the building. In some embodiments, the one or more colors may be at least one of red, green, orange etc. In one example, two or more visual indicators 526 may be operated to emit green color and sequentially blink to provide a safe evacuation path for the occupants. Further, one or more visual indicators 526 may be operated to emit red color to indicate an unsafe/hazardous zone, thereby alerting that the location of the event is nearby the one or more visual indicators 526 emitting the red color. Further, one or more visual indicators 526 may be operated to emit orange color to indicate that an unsafe zone is in proximity and alert the occupants to avoid approaching near the one or more visual indicators 526 emitting orange color.

In some embodiments, the evacuation path navigating module 516 may be configured to operate the visual indicators 526 to emit updated colors based on an updated evacuation path generated by the evacuation path generating module 514. The evacuation path navigating module 516 may be configured to dynamically update the evacuation path in real-time based on the location of the detected event. In some embodiments, the evacuation paths may be updated if one of the existing evacuation paths or emergency exits is compromised by a hazardous event such as fire, and that change may be indicated by the visual indicators 526 that update the colors to display the updated evacuation path and provide directional information pertaining to the updated evacuation path in of several ways.

In one embodiment, the evacuation path navigating module 516 may transmit one or more commands having timing information to the visual indicators 526. For example, the evacuation path navigating module 516 may broadcast a first command for one or more visual indicators 526 to blink at time t=X seconds, a second command to blink at time t=X+1 seconds, a third command to blink at time t=X+2 seconds, a fourth command to blink at time t=X+3 seconds, and a fifth command to blink at time t=X+4 seconds. The respective visual indicators 526 may be operated to sequentially blink based on the timing information provided in the commands.

As referred above, the one or more evacuation paths may be updated in real-time based on the hazardous event by operating the visual indicators 526 to emit one or more updated colors. In such case, timing of sequential blinking of the visual indicators 526 may also be updated to display the updated evacuation path. Thus, the sequential blinking and one or more colors emitted by visual indicators 526 may guide occupants to the shortest and safest evacuation path in minimal time.

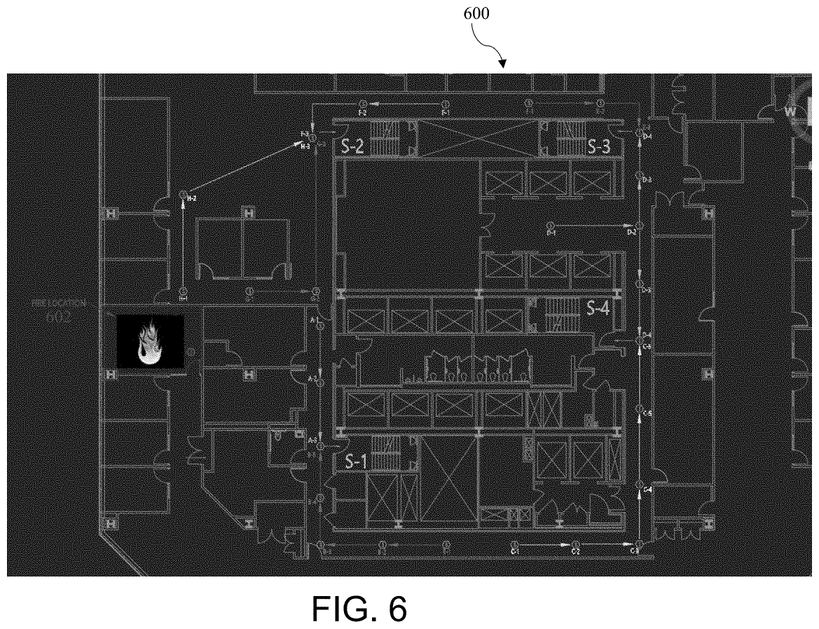

Referring now to FIG. 6, a schematic diagram showing an example of a floorplan displaying evacuation paths in case of a fire event detected in a room is illustrated, according to some embodiments.

The FIG. 6 shows an example of a floorplan 600 of a building. The floorplan 600 shows one or more sensors (such as smoke detectors A1-A3, B1-B5, C1-C6, D1-D4, E1-E3, F1-F3, G1-G3, H1-H3) installed at a plurality of spaces of the building. The smoke detectors transmit sensed data to the control panel 501 (shown in FIG. 5). The control panel 501 further analyzes the sensed data to detect occurrence of one or more events and determine location of the detected events. For example, the control panel 501 determines occurrence of a fire event and location 602 of the fire event. Further, each of the smoke detectors are associated with one or more visual indicators 526 (shown in FIG. 5) such as LED rings. Upon detection of fire, the control panel 501 determines one or more evacuation paths and operates the one or more LED rings to emit one or more colors for providing directional information to occupants in order to safely evacuate the building. For example, the control panel 501 operates one or more LED rings associated with one or more smoke detectors installed near the location 602 to emit red color indicating an unsafe zone, thereby alerting occupants to avoid approaching near the location 602. Further, the floorplan 600 shows one or more staircases S1, S2, S3 and S4. The control panel 501 operates one or more LED rings associated with smoke detectors installed at S1-S4 to sequentially blink and emit green color to indicate directional information, thereby alerting occupants of a safe evacuation path. For example, one or more LED rings associated with smoke detectors such as A1-A3, B1-B5, C1-C6, D1-D4, E1-E3, F1-F3, H1-H3, G1-G3 sequentially blink to emit green color. The occupants can follow the evacuation paths indicated by such LED rings to safely evacuate the building from one of the staircases S1-S4.

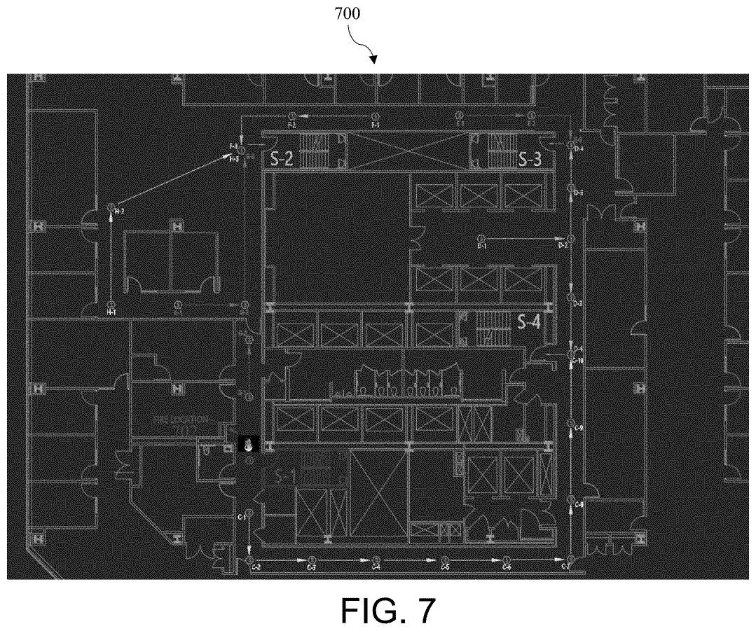

Referring now to FIG. 7, a schematic diagram showing an example of a floorplan displaying evacuation paths in case of a fire event detected near an emergency exit is illustrated, according to some embodiments.

The FIG. 7 shows an example of a floorplan 700 of a building. The floorplan 700 shows one or more sensors (such as smoke detectors C1-C10, D1-D4, E1-E3, F1-F3, G1-G3, H1-H3) installed at a plurality of spaces of the building. The smoke detectors transmit sensed data to the control panel 501 (shown in FIG. 5). The control panel 501 further analyzes the sensed data to detect occurrence of one or more events and determine location of the detected events. For example, the control panel 501 determines occurrence of a fire event and location 702 of the fire event at staircase S1. Further, one or more visual indicators 526 (shown in FIG. 5) such as LED rings are associated with each of the smoke detectors (C1-C10, D1-D4, E1-E3, F1-F3, G1-G3, H1-H3). Upon detection of fire, the control panel 501 determines one or more evacuation paths and operates the one or more LED rings to emit one or more colors for providing directional information to occupants in order to safely evacuate the building. The control panel 501 operates one or more LED rings associated with one or more smoke detectors installed near the location 702 to emit red color indicating an unsafe zone, thereby alerting occupants to avoid approaching near the location 702. The control panel 501 operates one or more LED rings associated with smoke detectors installed at staircases S2-S4 to sequentially blink and emit green color to provide directional information, thereby alerting occupants of a safe evacuation path. For example, one or more LED rings associated with smoke detectors such as C2-C10, D1-D4, E1-E3, F1-F3, H1-H3 etc., sequentially blink to emit green color. The occupants can follow the evacuation path indicated by such LED rings to safely evacuate the building using one of the staircases S2-S4. In addition, LED rings of smoke detectors C1 and G1 emit orange color to alert the occupants to avoid approaching near C1 and G1, as a fire event is detected at a nearby location 702 by the smoke detector S1 proximal to the smoke detectors C1 and G1.

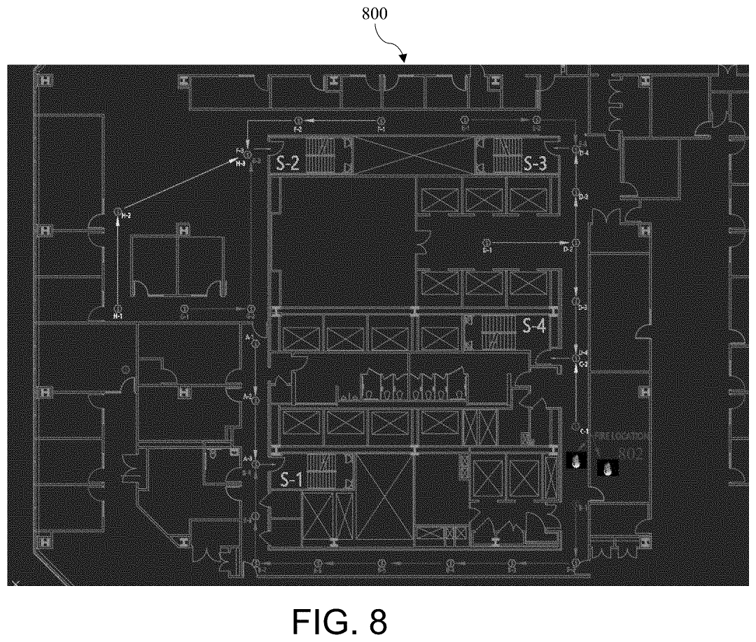

Referring now to FIG. 8, a schematic diagram showing an example of a floorplan displaying evacuation paths in case of a fire event detected in a corridor is illustrated, according to some embodiments.

The FIG. 8 shows an example of a floorplan 800 of a building. The floorplan 800 shows one or more sensors (such as smoke detectors A1-A3, B1-B9, C1-C2, D1-D4, E1-E3, F1-F3, G1-G3, H1-H3) installed at a plurality of spaces of the building. The smoke detectors transmit sensed data to the control panel 501 (shown in FIG. 5.) The control panel 501 further analyzes the sensed data to detect occurrence of one or more events and determine location of the detected events. For example, the control panel 501 determines occurrence of a fire event and location 802 of the fire event in a corridor. Further, one or more visual indicators 526 (shown in FIG. 5) such as LED rings are associated with each of the smoke detectors (A1-A3, B1-B9, C1-C2, D1-D4, E1-E3, F1-F3, G1-G3, H1-H3). Upon detection of fire, the control panel 501 determines one or more evacuation paths and operates the one or more LED rings to emit one or more colors for providing directional information to occupants in order to safely evacuate the building. The control panel 501 operates one or more LED rings associated with one or more smoke detectors B1 and C1 installed near the location 802 to emit red color indicating an unsafe zone, thereby alerting occupants to avoid approaching near the location 802. Further, the floorplan 600 shows one or more staircases S1, S2, S3 and S4. The control panel 501 operates one or more LED rings associated with smoke detectors installed at S1-S4 to sequentially blink and emit green color to provide directional information, thereby alerting occupants of a safe evacuation path. For example, one or more LED rings associated with smoke detectors such as A1-A3, B3-B9, D1-D4, E1-E3, F1-F3, H1-H3, G1-G3 sequentially blink to emit green color. The occupants can follow the evacuation path indicated by such LED rings to safely evacuate the building from one of the staircases S1-S4. In addition, LED rings of smoke detectors B2 and C2 emit orange color to alert the occupants to avoid approaching near B2 and C2 as a fire event is detected at a nearby location 802 by the smoke detectors B1, C1 proximal to the smoke detectors B2 and C2.

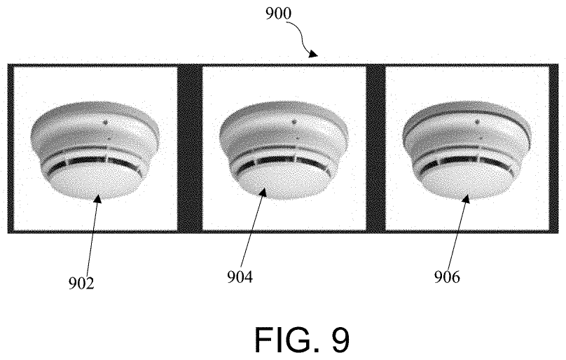

Referring now to FIG. 9, an example of security devices of FIG. 5 are illustrated, according to some embodiments.

The example 900 shows the sensors 524 such as smoke detectors 902, 904, 906 provided with one or more visual indicators (such as visual indicators 526 shown in FIG. 5). The example 900 shows the smoke detector 902 having an LED ring emitting green color to provide directional information for guiding occupants along one or more safe evacuation paths. Further, the smoke detector 904 is shown to have an LED ring emitting orange color to indicate occurrence of a potential hazardous event nearby and alerting occupants to avoid approaching near the smoke detector 904. Further, the smoke detector 906 is shown to have an LED ring emitting red color indicating that the smoke detector 906 has detected occurrence of a hazardous event such as fire. The LED ring of the smoke detector 906 emitting red color indicates an unsafe zone, thereby alerting occupants to avoid approaching near the smoke detector 906.

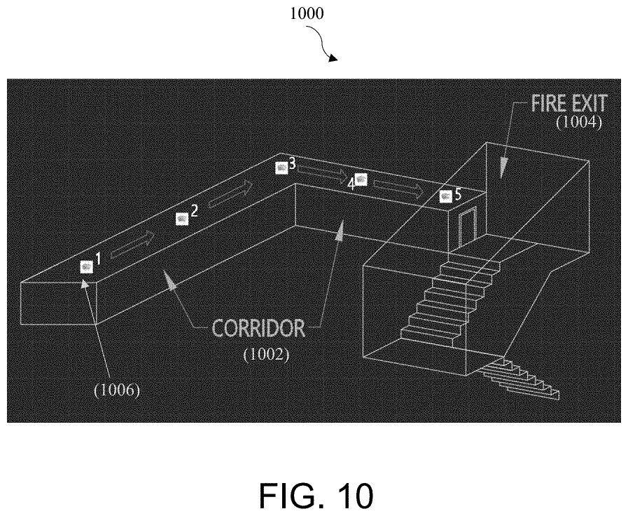

Referring now to FIG. 10, a schematic diagram showing an example of an evacuation path displayed by the system 500 of FIG. 5 for color blind occupants is illustrated, according to some embodiments.

The FIG. 10 shows a building space 1000 having a corridor 1002 and a fire exit 1004. Further, the corridor 1002 has one or more sensors 1006 provided with one or more visual indicators such as LED rings that are blinking in sequence, for example, 1-2-3-4-5 to provide directional information pertaining to one or more evacuation paths for assisting occupants that are color blind. The color blind occupants may see single colored LED rings blinking in sequence based on commands received from the control panel 501 to provide the directional information for safe evacuation from the building. In addition, one or more non-blinking single colored LED rings associated with one or more sensors 1006 may provide an alert of occurrence of a hazardous event nearby, thereby suggesting the building occupant to avoid approaching near such LED rings.

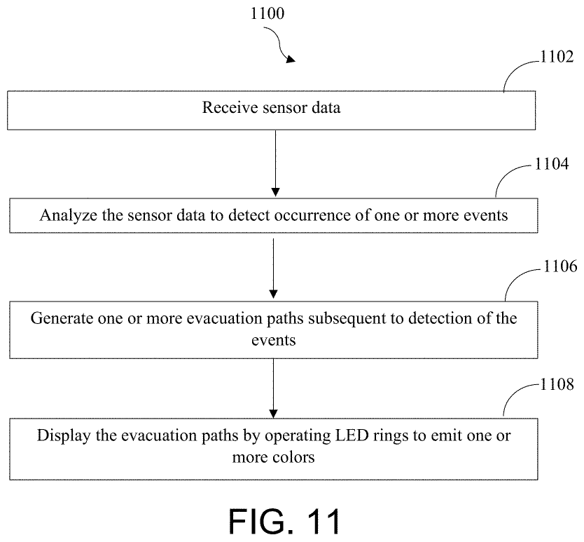

Referring now to FIG. 11, a flow chart of a method 1100 for providing evacuation guidance through LED rings is shown, according to an exemplary embodiment. In some embodiments, the method 1100 is performed by the system 500 referred above in FIG. 5. Alternatively, the method 1100 may be partially or completely performed by another system or controller of the BMS referred above.

Further, the method 1100 is shown to include receiving the sensed data (Step 1102). The sensed data may be received from the one or more sensors 524 (referred above in FIG. 5). In some embodiments, the sensed data may be received by the sensed data receiving module 510 (referred above in FIG. 5). For example, the sensed data may include values of one or more parameters of an indoor space monitored by the sensors 524 such as smoke, oxygen, occupancy, pressure, temperature, humidity, sound, motion etc. Additionally, the unique identifiers of the one or more sensors 524 may be transmitted along with the sensed data to the sensed data receiving module 510.

Further, the method 1100 is shown to include detecting occurrence of one or more events (Step 1104). In some embodiments, the occurrence of one or more events may be detected by the event detection module 512 (referred above in FIG. 5). The sensed data may be analyzed to detect occurrence of one or more events within the building. For example, the one or more events may include at least one of, but not limited to, fire, flood, earthquake, oxygen deficiency, terrorist attack, gunshot, gas leakage, damaging of one or more building equipment and the like. The sensed data may be compared with one or more predetermined threshold values of sensed data stored in the database 518. For example, the occurrence of one or more events such as fire may be detected when sensed data provided by one or more smoke detectors exceeds the predetermined threshold value. In another example, oxygen deficiency within the building may be detected, when the sensed data such as measured oxygen level provided by the oxygen detector falls below the predetermined threshold value.

In some embodiments, sensed data received from multiple sensors 524 may be analyzed. For example, sensed data from fire sensors, smoke detectors, heat sensors, thermal imagers, and other fire system sensors may be analyzed to determine that it is likely that a fire event has occurred in the building. Thus, by analyzing sensed data from multiple sensors 524, a probability of detecting a false event may be reduced significantly. In some embodiments, one or more machine learning models stored in the database 518 may be utilized to analyze the sensed data for detection of one or more events.

Further, the method 1100 is shown to include generating one or more evacuation paths (Step 1106). In some embodiments, the one or more evacuation paths may be determined and generated by the evacuation path generating module 514 (referred above in FIG. 5). As referred above, the unique identifiers of the one or more sensors 524 may be transmitted along with the sensed data. Thus, subsequent to detection of the event, the unique identifiers of the one or more sensors 524 generating the sensed data may be determined. Further, a location of installation of the one or more sensors 524 may be determined based on the unique identifiers of the one or more sensors 524 by using the pre-stored building model 520 in the database 518. Further, a location of occurrence of the event within the building may be determined based on the location of installation of the one or more sensors 524.

Additionally, one or more emergency exits and one or more paths to the one or more emergency exits may be determined using the pre-stored building model 520. The location of event may be analyzed with respect to the location of the one or more emergency exits to check if the occurrence of event is detected nearby any of the emergency exits. Further, the one or more evacuation paths to the one or more emergency exits may be determined based on the analysis of the location of the event and the location of the one or more emergency exits. The one or more evacuation paths may be determined by avoiding the paths nearby the location of the detected event. In some embodiments, one or more artificial intelligence and/or machine learning based models stored in the database 518 may be utilized to determine one or more evacuation paths for occupants.

Further, the method 1100 is shown to include displaying the one or more evacuation paths by operating LED rings to emit one or more colors (Step 1108). In some embodiments, the one or more evacuation paths may be displayed by the evacuation path navigating module 516 (referred above in FIG. 5). In some embodiments, the visual indicators 526 such as LED rings associated with the sensors 524 may be operated to emit one or more colors. In some embodiments, the one or more colors may indicate one or more types of directional information for occupants to safely evacuate the building. In some embodiments, the one or more colors may be at least one of red, green, orange etc. In one example, two or more LED rings may be operated to emit green color and sequentially blink to indicate a safe evacuation path for the occupants. Further, one or more LED rings may be operated to emit red color to indicate an unsafe zone, thereby alerting that the location of the event is nearby the one or more LED rings emitting the red color. Further, one or more LED rings may be operated to emit orange color to indicate that an unsafe zone is in proximity and alert the occupants to avoid approaching near the one or more LED rings.

In some embodiments, the LED rings may be operated to emit updated colors based on an updated evacuation path generated by the evacuation path generating module 514. The one or more evacuation paths may be dynamically updated in real-time based on the location of the detected event. In some embodiments, the one or more evacuation paths may be updated if one of the existing evacuation paths or emergency exits is compromised by a hazardous event such as fire, and that change may be indicated by the LED rings that update the colors to display the updated evacuation paths and provide directional information in of several ways.

In one embodiment, a one or more commands having timing information may be transmitted to the visual indicators 526. For example, a first command may be transmitted for one or more LED rings to blink at time t=X seconds, a second command to blink at time t=X+1 seconds, a third command to blink at time t=X+2 seconds, a fourth command to blink at time t=X+3 seconds, and a fifth command to blink at time t=X+4 seconds. The respective LED rings may be operated to sequentially blink based on the timing information provided in the commands.

In some embodiments, the one or more evacuation paths may be updated in real-time based on the hazardous event by operating the LED rings to emit one or more updated colors. In such case, timing of sequential blinking of the LED rings may also be updated to display the updated evacuation path. The sequential blinking and one or more colors emitted by the LED rings associated with the sensors 524 may guide occupants to the shortest and safest evacuation path in minimal time.

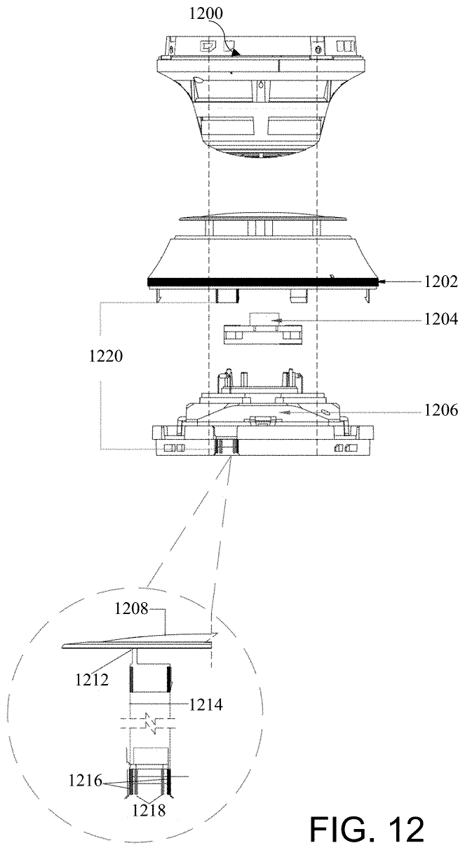

Referring now to FIG. 12, a schematic diagram showing an assembly having a smoke detector and oxygen sensor is illustrated, according to some embodiments.

The FIG. 12 shows an assembly 1200 comprising a smoke detector 1206 and an associated oxygen sensor 1204. In some embodiments, the smoke detector 1206 and the oxygen sensor 1204 may be alternatively referred as the sensors 524. In some embodiments, the oxygen sensor 1204 may be installed on the base of the smoke detector 1206. The oxygen sensor 1204 may be an electrochemical cell measuring oxygen concentration in air may be added to the smoke detector 1206. In some embodiments, the electrochemical cell measures oxygen concentration in ambient air and creates an electrical output proportional to the oxygen level. For example, the electrochemical cell may produce a current proportional to the concentration of oxygen. In some embodiments, the oxygen sensor 1204 and the smoke detector 1206 may be set on respective threshold values. In some embodiments, each of the oxygen sensor 1204 and the smoke detector 1206 may provide sensed data to the control panel 501 containing measured values of one or more parameters such as smoke, oxygen.

In some embodiments, visual indicators 526 such as one or more LED strips 1202 may be provided on the assembly 1200. Further, 1220 shows contacts for LED strips 1202 and smoke detector 1206. The LED strips 1202 may provide directional information to guide occupants to evacuate the building in case of deficiency of oxygen detected by the oxygen sensor 1204. In one embodiment, for a closed room, one or more LED strips 1202 may be provided on a perimeter of the smoke detector 1206 that may be operated to emit red color to alert occupants about oxygen deficiency in the closed room. In another embodiment, for a corridor space, an LED strip may be provided on one side of the smoke detector 1206 that may be operated to emit green color to indicate a safe evacuation path and another LED strip may be provided on other side of the smoke detector 1206 that may be operated to emit red color to indicate a hazardous path.

In some embodiments, a power source such as 24 VDC power may be added at the base for the LED strips 1202. In some embodiments, a 30 inch spacing may be provided between the smoke detector 1206 and the oxygen sensor 1204. Further, 1208 shows a top portion of the assembly 1200, 1212 shows power supply connections for LED strips 1202, 1214 shows internal wiring, 1216 shows circuit contact on smoke detector circuit base for LED strips 1202, 1218 shows circuit contact on smoke detector circuit base to make connection for smoke detector 1206 and oxygen sensor 1204.

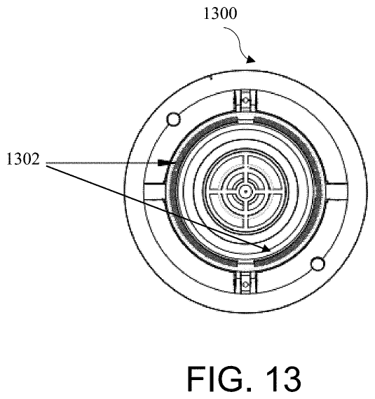

Referring now to FIG. 13, a schematic diagram showing a visual indicator associated with the smoke detector of FIG. 12 is illustrated, according to some embodiments.

The schematic diagram shows a visual indicator such as LED strips 1302 associated with the smoke detector 1300. The LED strips 1302 may be operated by the control panel 501 to emit one or more colors such as red or green to provide directional information to occupants for evacuating the building along a safe evacuation path in case of occurrence of a hazardous event in the building. The one or more colors emitted by the LED strips 1302 may provide one or more types of directional information. For example, the LED strip 1302 while emitting red color may indicate an unsafe zone, thereby alerting the occupants to avoid approaching in the direction. Additionally, the LED strip 1302 while emitting green color may indicate a safe evacuation path, thereby alerting occupants to traverse along the evacuation path to safely evacuate the building via the safest emergency exit.

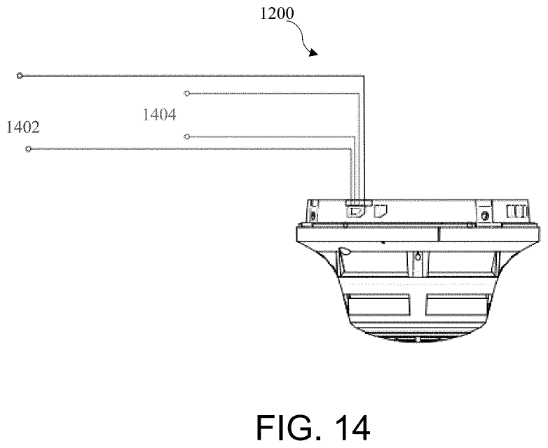

Referring now to FIG. 14, a schematic diagram showing wiring details of the assembly of FIG. 12 is illustrated, according to some embodiments.

The schematic diagram shows wiring details for the assembly 1200 such as a 24V external power supply may be added at 1402 for LED strips 1202 (referred above in FIG. 12). In addition, an SLC data cable may be provided at 1404.

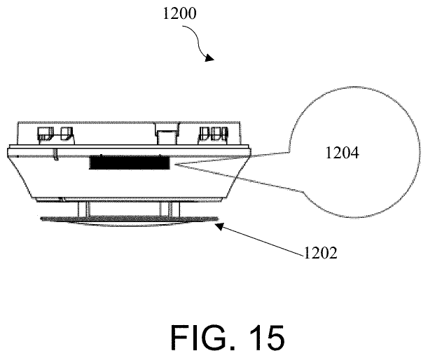

Referring now to FIG. 15, a schematic diagram showing another view of the assembly of FIG. 12 is illustrated, according to some embodiments.

The schematic diagram shows the assembly 1200 having the oxygen sensor 1204. Further, as referred above, the oxygen sensor 1204 may include an electrochemical cell configured to measure oxygen level within the building and provide sensed data regarding measured oxygen levels to the control panel 501 (shown in FIG. 5). Further, the LED strips 1202 may be provided on the assembly 1200. The LED strips 1202 may be operated by the control panel 501 to emit one or more colors to provide directional information for safe evacuation from the building based on analysis of the sensed data received from at least one of the smoke detector 1206, or the oxygen sensor 1204.

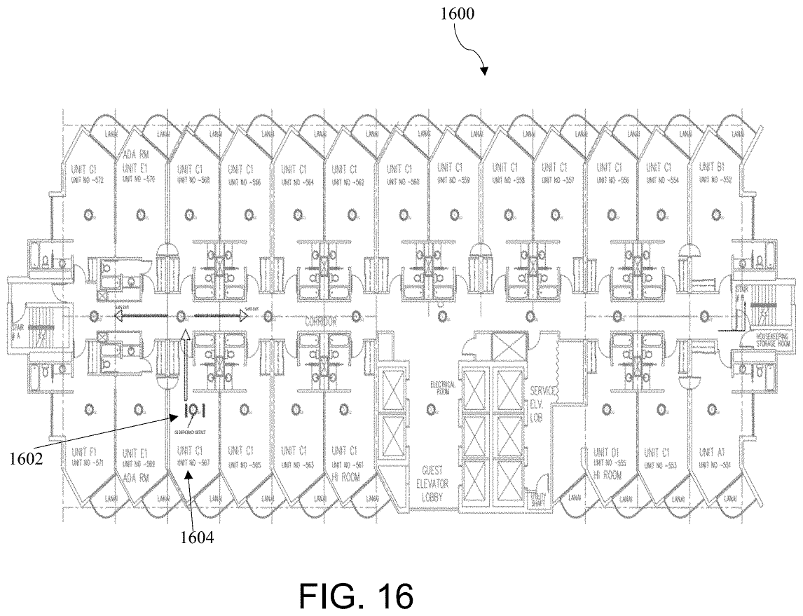

Referring now to FIG. 16, a schematic diagram showing an example of a floor plan displaying evacuation paths in case of oxygen deficiency in a closed room is illustrated, according to some embodiments.

The FIG. 16 shows an example of a floor plan 1600 having an assembly 1602 of a smoke detector and oxygen sensor with two LED strips emitting red color to indicate oxygen deficiency in a room such as Unit C1 at 1604. In such cases, when oxygen deficiency is detected for a closed room, one or more LED strips may be provided on the smoke detector that may be operated to emit red color to alert occupants to avoid entering the room due to oxygen deficiency.

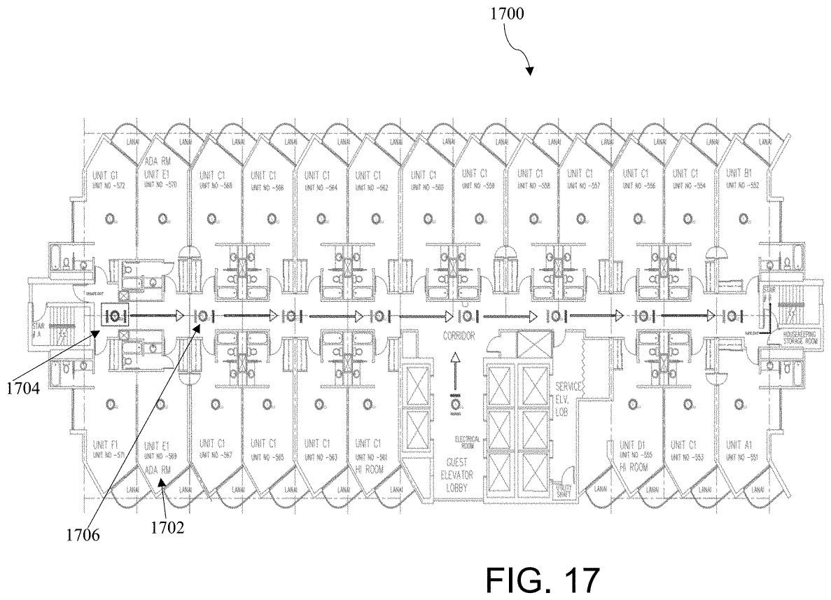

Referring now to FIG. 17, a schematic diagram showing an example of a floor plan displaying evacuation paths in case of oxygen deficiency in corridors, according to some embodiments.

The FIG. 17 shows an example of a floor plan 1700 having an assembly 1704 of a smoke detector and oxygen sensor provided with two LED strips emitting red color based on one or more commands received from the control panel 501 to indicate oxygen deficiency in a corridor. Further, one or more additional assemblies 1706 are provided at different spaces of the building. In such cases, when oxygen deficiency is detected for a corridor, two LED strips may be provided on the assembly 1706 that may be operated to emit one or more colors to provide directional information to occupants for evacuating the building. For example, the two LED strips may comprise an LED strip emitting red color and provided on one side of the smoke detector to alert occupants to avoid proceeding in the direction forward as there is an oxygen deficiency in zones proximal to the smoke detector. In addition, the two LED strips may comprise an LED strip emitting green color and provided on other side of the smoke detector to allow occupants to proceed in the direction forward for safely evacuating from the building.

For example, one or more occupants approaching the corridor from Unit E1 shown at 1702 may observe that the assembly 1704 in the left direction is emitting red color indicating an unsafe zone. Thus, the occupants may avoid proceeding in the left direction towards assembly 1704. On the other hand, the occupants may observe that assembly 1706 in the right direction is emitting green color indicating a safe zone. Thus, the occupants may proceed in the right direction towards assembly 1706 to safely evacuate the building.

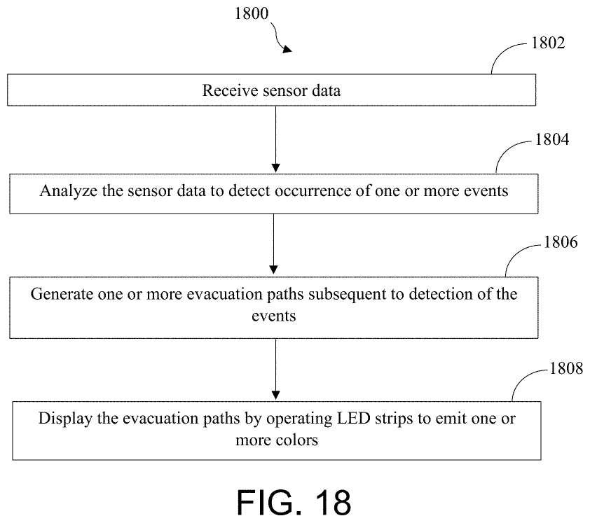

Referring now to FIG. 18, a flow chart of a method 1800 for providing evacuation guidance through LED strips is shown, according to an exemplary embodiment. In some embodiments, the method 1800 is performed by the system 500 referred above in FIG. 5. Alternatively, the method 1800 may be partially or completely performed by another system or controller of the BMS referred above.

The method 1800 is shown to include receiving the sensed data (Step 1802). The sensed data may be received from the one or more sensors 524 (referred above in FIG. 5). In some embodiments, the sensed data may be received by the sensed data receiving module 510 (referred above in FIG. 5). For example, the sensed data may include values of one or more parameters monitored by the sensors 524 such as smoke, oxygen, occupancy, pressure, temperature, humidity, sound, motion etc. Additionally, the unique identifiers of the one or more sensors 524 may be transmitted along with the sensed data to the sensed data receiving module 510.

Further, the method 1800 is shown to include detecting occurrence of one or more events (Step 1804). In some embodiments, the occurrence of one or more events may be detected by the event detection module 512 (referred above in FIG. 5). The sensed data may be analyzed to detect occurrence of one or more events within the building. For example, the one or more events may include at least one of, but not limited to, fire, flood, earthquake, oxygen deficiency, terrorist attack, gunshot, gas leakage, damaging of one or more building equipment and the like. The sensed data may be compared with one or more predetermined threshold values of sensed data stored in the database 518. For example, the occurrence of one or more events such as fire may be detected when sensed data provided by one or more smoke detectors exceeds the predetermined threshold value. In another example, oxygen deficiency within the building may be detected, when the sensed data such as measured oxygen level provided by the oxygen detector falls below the predetermined threshold value.

Further, in some embodiments, sensed data received from multiple sensors 524 may be analyzed. For example, sensed data from fire sensors, smoke detectors, heat sensors, thermal imagers, or other fire system sensors may be analyzed to determine that it is likely that a fire event has occurred in the building. Thus, by analyzing sensed data from multiple sensors 524, a probability of detecting a false event may be reduced significantly. In some embodiments, one or more machine learning models stored in the database 518 may be utilized to analyze the sensed data for detection of one or more events.

Further, the method 1800 is shown to include generating one or more evacuation paths (Step 1806). In some embodiments, the one or more evacuation paths may be determined and generated by the evacuation path generating module 514 (referred above in FIG. 5). As referred above, the unique identifiers of the one or more sensors 524 may be transmitted along with the sensed data. Thus, subsequent to detection of the event, the unique identifiers of the one or more sensors 524 generating the sensed data may be determined. Further, a location of installation of the one or more sensors 524 may be determined based on the unique identifiers of the one or more sensors 524 by using the pre-stored building model 520 in the database 518. Further, a location of occurrence of the event within the building may be determined based on the location of installation of the one or more sensors 524.

Furthermore, one or more emergency exits and one or more paths to the one or more emergency exits may be determined using the pre-stored building model 520. The location of the event may be analyzed with respect to the location of the one or more emergency exits to check if the occurrence of the event is detected nearby any of the emergency exits. Further, the one or more evacuation paths to the one or more emergency exits may be determined based on the analysis of the location of the event and the location of the one or more emergency exits. The one or more evacuation paths may be determined by avoiding the paths nearby the location of the detected event. In some embodiments, one or more artificial intelligence and/or machine learning models stored in the database 518 may be utilized to determine one or more evacuation paths for occupants.

Further, the method 1800 is shown to include displaying the one or more evacuation paths by operating one or more LED strips to emit one or more colors (Step 1808). In some embodiments, the one or more evacuation paths may be displayed by the evacuation path navigating module 516 (referred above in FIG. 5). In some embodiments, the visual indicators 526 such as LED strips associated with the sensors 524 may be operated to emit one or more colors. In some embodiments, the one or more colors may indicate one or more types of directional information for occupants to safely evacuate the building. In some embodiments, the one or more colors may be at least one of red and green. In one example, one or more LED strips may be operated by the evacuation path navigating module 516 to emit green color to indicate a safe evacuation path for the occupants. Further, one or more LED strips may be operated by the evacuation path navigating module 516 to emit red color to indicate a hazardous zone, thereby alerting that the location of the event is nearby the one or more LED strips emitting the red color.

In some embodiments, the LED strips may be operated to emit updated colors based on an updated evacuation path generated by the evacuation path generating module 514. The one or more evacuation paths may be dynamically updated in real-time based on the location of the detected event. In some embodiments, the one or more evacuation paths may be updated if one of the existing evacuation paths or emergency exits is compromised by a hazardous event such as fire, and that change may be indicated by the LED strips that update the colors to display the updated evacuation paths and provide directional information in of several ways. The colors emitted by the LED strips associated with the sensors 524 may guide occupants to the shortest and safest evacuation path in minimal time.

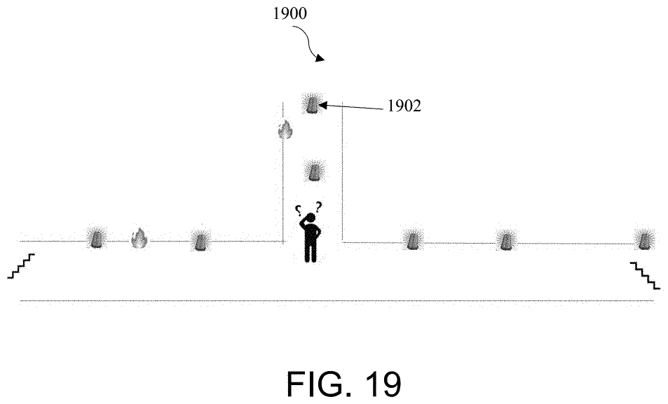

Referring now to FIG. 19, an example of a building space with smoke detectors triggering an alarm is illustrated, according to some embodiments.

The schematic diagram shows an example of a building space 1900 having a plurality of smoke detectors 1902 installed at one or more locations within the building space 1900. The plurality of smoke detectors 1902 are triggering an alarm due to detection of occurrence of a fire event in the building space 1900. In case of plurality of smoke detectors 1902 triggering an alarm, a panic situation may be created, as occupants fail to determine an evacuation path to safely evacuate the building space 1900.

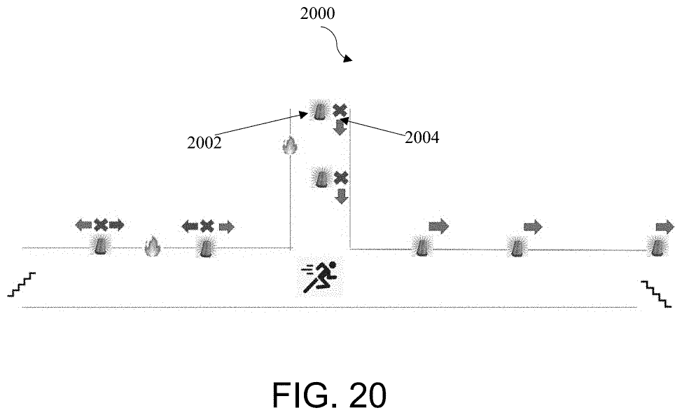

Referring now to FIG. 20, a schematic diagram showing an example of an evacuation path displayed by illuminating direction signages is illustrated, according to some embodiments.

The schematic diagram shows an example of a building space 2000 having a plurality of smoke detectors 2002 installed at one or more locations within the building space 2000. The plurality of smoke detectors 2002 are triggering an alarm due to detection of occurrence of a fire event in the building space 2000 by the control panel 501. Additionally, each of the smoke detector 2002 is provided with one or more direction signages 2004 that emit one or more colors to provide directional information to occupants for evacuating the building. For example, the one or more colors may be least one of, but not limited to, red, green etc. The color emitted by the direction signages 2004 may depend on the location of occurrence of hazardous event such as fire. For example, the direction signages 2004 may be operated to emit red color indicating an unsafe zone and alerting occupants to avoid proceeding in that direction. Additionally, the direction signages 2004 may be operated to emit green color indicating a safe evacuation path, thereby alerting occupants to proceed in that direction to safely evacuate the building.

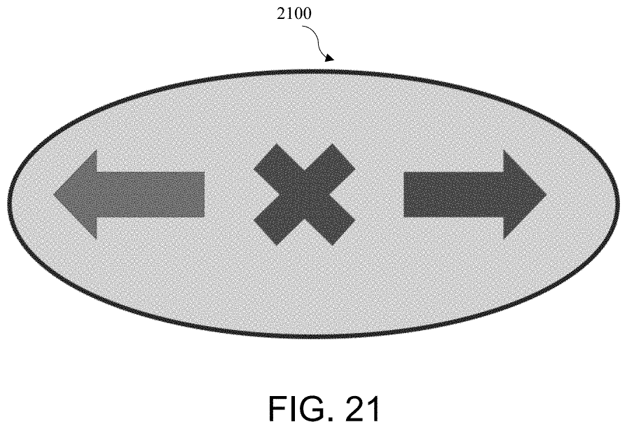

Referring now to FIG. 21, an example of direction signages for providing evacuation guidance is illustrated, according to some embodiments.

The FIG. 21 shows an example of a direction signage 2100 that can be associated with the sensors 524, for example smoke detectors. The direction signage 2100 may include a cross sign and one or more arrows emitting one or more colors to indicate directional information. For example, the direction signage 2100 may include an arrow emitting green color to indicate a safe evacuation path, thereby alerting occupants to proceed in that direction to safely evacuate the building. Additionally, the direction signage 2100 may include an arrow emitting red color indicating an unsafe zone and alerting occupants to avoid proceeding in that direction.

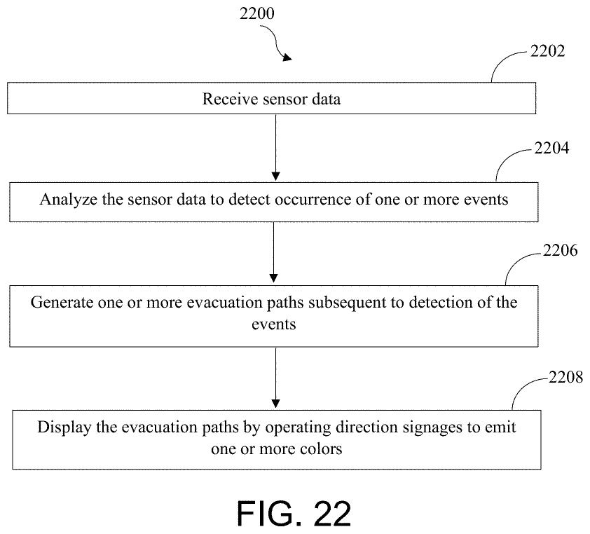

Referring now to FIG. 22, a flow chart of a method 2200 for providing evacuation guidance through illuminating direction signages is shown, according to an exemplary embodiment. In some embodiments, the method 2200 is performed by the system 500 referred above in FIG. 5. Alternatively, the method 2200 may be partially or completely performed by another system or controller of the BMS referred above.

Further, the method 2200 is shown to include receiving the sensed data (Step 2202). The sensed data may be received from the one or more sensors 524 (referred above in FIG. 5). In some embodiments, the sensed data may be received by the sensed data receiving module 510 (referred above in FIG. 5). For example, the sensed data may include values of one or more parameters monitored by the sensors 524 such as smoke, oxygen, occupancy, pressure, temperature, humidity, sound, motion etc. Additionally, the unique identifiers of the one or more sensors 524 may be transmitted along with the sensed data to the sensed data receiving module 510.

Further, the method 2200 is shown to include detecting occurrence of one or more events (Step 2204). In some embodiments, the occurrence of one or more events may be detected by the event detection module 512 (referred above in FIG. 5). The sensed data may be analyzed to detect occurrence of one or more events within the building. For example, the one or more events may include at least one of, but not limited to, fire, flood, earthquake, oxygen deficiency, terrorist attack, gunshot, gas leakage, damaging of one or more building equipment and the like. The sensed data may be compared with one or more predetermined threshold values of sensed data stored in the database 518. For example, the occurrence of one or more events such as fire may be detected when sensed data provided by one or more smoke detectors exceeds the predetermined threshold value. In another example, oxygen deficiency within the building may be detected, when the sensed data such as measured oxygen level provided by the oxygen detector falls below the predetermined threshold value. In some embodiments, one or more machine learning models stored in the database 518 may be utilized to analyze the sensed data for detection of one or more events.

Further, the method 2200 is shown to include generating one or more evacuation paths (Step 2206). In some embodiments, the one or more evacuation paths may be determined and generated by the evacuation path generating module 514 (referred above in FIG. 5). As referred above, the unique identifiers of the one or more sensors 524 may be transmitted along with the sensed data. Thus, subsequent to detection of the event, the unique identifiers of the one or more sensors 524 generating the sensed data may be determined. Further, a location of installation of the one or more sensors 524 may be determined based on the unique identifiers of the one or more sensors 524 by using the pre-stored building model 520 in the database 518. Further, a location of occurrence of the event within the building may be determined based on the location of installation of the one or more sensors 524.

Further, one or more emergency exits and one or more paths to the one or more emergency exits may be determined using the building model 520 stored in the database 518. The location of the event may be analyzed with respect to the location of the one or more emergency exits to check if the occurrence of event is detected nearby any of the emergency exits. Further, the one or more evacuation paths to the one or more emergency exits may be determined based on the analysis of the location of the event and the location of the one or more emergency exits. The one or more evacuation paths may be determined by avoiding the paths nearby the location of the detected event. In some embodiments, one or more artificial intelligence and/or machine learning based models stored in the database 518 may be utilized to determine one or more evacuation paths for occupants.

Further, the method 2200 is shown to include displaying the one or more evacuation paths by operating direction signages to emit one or more colors (Step 2208). In some embodiments, the one or more evacuation paths may be displayed by the evacuation path navigating module 516 (referred above in FIG. 5). In some embodiments, the direction signages 2100 (referred above in FIG. 21) associated with each of the sensors 524 may be operated to emit one or more colors. In some embodiments, the one or more colors may indicate one or more types of directional information for occupants to safely evacuate the building. In some embodiments, the one or more colors may be least one of red, green etc. In one example, one or more directional signages 2100 may be operated to emit green color to indicate a safe evacuation path for the occupants. Further, one or more directional signages 2100 may be operated to emit red color to indicate a hazardous zone, thereby alerting that the location of the event is nearby the sensors 524 associated with the directional signages emitting the red color.

In some embodiments, the direction signages 2100 may be operated to emit updated colors based on an updated evacuation path generated by the evacuation path generating module 514. The one or more evacuation paths may be dynamically updated in real-time based on the location of the detected event. In some embodiments, the one or more evacuation paths may be updated if one of the existing evacuation paths or emergency exits is compromised by a hazardous event such as fire, and that change may be indicated by the direction signages 2100 that update the colors to display the updated evacuation paths and provide directional information in of several ways. The one or more colors emitted by the direction signages 2100 associated with the sensors 524 may guide occupants to the shortest and safest evacuation path in minimal time.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1.-19. (canceled)

20. A system comprising:
a plurality of sensors, wherein each sensor is configured to monitor at least one parameter of an indoor space and to generate sensed data, at least a subset of the plurality of sensors are configured to monitor for an event;
one or more visual indicators associated with each sensor of the plurality of sensors; and
a processor configured to:
analyze the sensed data to detect occurrence of an event;
determine an approximate location of the event;
generate one or more evacuation paths in response to the determining the approximate location of the event in which the one or more evacuation paths avoid the approximate location of the event; and
operate the one or more visual indicators associated with each sensor to provide directional information to occupants based on the one or more evacuation paths.

21. The system of claim 20, wherein the at least one parameter includes at least one of smoke, oxygen, occupancy, pressure, temperature, humidity, sound, and motion.

22. The system of claim 20, wherein the processor generates the one or more evacuation paths in response to determining the approximate location of the event using a pre-stored building model.

23. The system of claim 20, wherein the processor generates the one or more evacuation paths in response to determining the approximate location of the event using a pre-stored building model and an identifier corresponding to the sensor that provided the sensed data used to detect the occurrence of the event.

24. The system of claim 20, wherein the event is a gunshot.

25. The system of claim 20, wherein the generating one or more evacuation paths is dynamically generated.

26. The system of claim 20, wherein the one or more visual indicators are integrated into the sensors.

27. The system of claim 20, wherein the one or more visual indicators are mounted on the sensors.

28. The system of claim 20, wherein the visual indicator is one of an light emitting diode (LED) ring, an LED strip, an illuminating direction signage, or any combination thereof.

29. The system of claim 20, wherein the processor is configured to operate the one or more visual indicators to sequentially blink to provide the directional information based on the one or more evacuation paths.

30. The system of claim 20, wherein the processor is configured to operate the one or more visual indicators to provide the directional information by emitting one or more colors.

31. The system of claim 30, wherein the processor is configured to operate the one or more visual indicators to emit green color to indicate a safe evacuation path.

32. The system of claim 30, wherein the processor is configured to operate the one or more visual indicators to emit red color to indicate an unsafe zone.

33. The system of claim 30, wherein the processor is configured to operate the one or more visual indicators to emit orange color to indicate an alert of an unsafe zone proximal to the one or more visual indicators.

34. A method comprising:
analyzing, by a processor, sensed data generated by a plurality of sensors monitoring at least one parameter of an indoor space and to generate the sensed data, at least a subset of the plurality of sensors are configured to monitor for an event;
determining, by the processor, an approximate location of the event;
generating, by the processor, one or more evacuation paths in response to the determining the approximate location of the event in which the one or more evacuation paths avoid the approximate location of the event; and
operating, by the processor, one or more visual indicators associated with each sensor to provide directional information to occupants based on the one or more evacuation paths.

35. The method of claim 34, wherein the at least one parameter includes at least one of smoke, oxygen, occupancy, pressure, temperature, humidity, sound, and motion.

36. The method of claim 34, wherein generating one or more evacuation paths is in response to determining the approximate location of the event using a pre-stored building model.

37. The method of claim 34, wherein the generating one or more evacuation paths is in response to determining the approximate location of the event using a pre-stored building model and an identifier corresponding to the sensor that provided the sensed data used to detect the occurrence of the event.

38. The method of claim 34, wherein the event is a gunshot.

39. The method of claim 34, wherein the generating one or more evacuation paths is dynamically generated.

40. The method of claim 34, wherein the one or more visual indicators are operated by the processor to provide the directional information by emitting one or more colors.

41. The method of claim 40, wherein the one or more visual indicators are operated by the processor to emit green color to indicate a safe evacuation path.

42. The method of claim 40, wherein the one or more visual indicators are operated by the processor to emit red color to indicate an unsafe zone.

43. The method of claim 40, wherein the one or more visual indicators are operated by the processor to emit orange color to indicate an alert of an unsafe zone proximal to the one or more visual indicators.

44. The method of claim 34, wherein the one or more visual indicators are operated by the processor to sequentially blink to provide the directional information based on the one or more evacuation paths.
